(19) United States
(12) Patent Application Publication
(10) Pub. No.: US 2019/0356043 A1
(43) Pub. Date: Nov. 21, 2019

(54) Rod Antenna Having Anti-Whistle Coil

(71) Applicant: Hirschmann Car Communication GmbH, Neckartenzlingen (DE)

(72) Inventors: Janos Kiss, Bekescsaba (HU); Attila Berecz, Farkaslyuk (HU); Attila Laurinyecz, Bekescsaba (HU)

(73) Assignee: Hirschmann Car Communication GmbH, Neckartenzlingen (DE)

(21) Appl. No.: 16/530,311

(22) Filed: Aug. 2, 2019

Related U.S. Application Data
(63) Continuation of application No. PCT/EP2018/050121, filed on Jan. 3, 2018.

(30) Foreign Application Priority Data
Feb. 2, 2017 (DE) 102017102050.0

(51) Int. Cl. H01Q 1/32

(52) U.S. Cl. CPC H01Q 1/3275

(57) ABSTRACT

A rod antenna includes a jacket enclosing an electrical conductor acting as an antenna. The jacket has a groove extending in a spiral manner in an axial direction of the rod antenna.

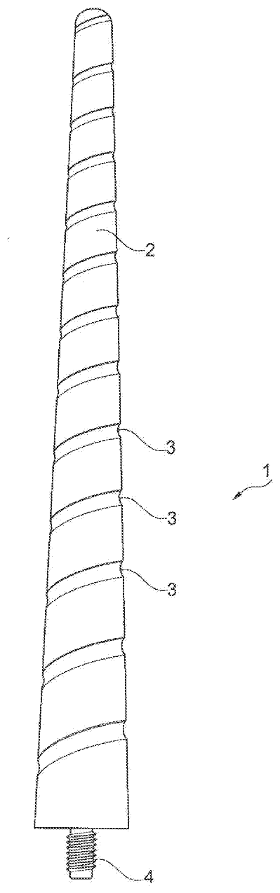

### CROSS-REFERENCE TO RELATED APPLICATIONS

This application is a continuation of PCT International Application No. PCT/EP2018/050121, filed on Jan. 3, 2018, which claims priority under 35 U.S.C. § 119 to German Patent Application No. 102017102050.0, filed on Feb. 2, 2017.

### FIELD OF THE INVENTION

The present invention relates to a rod antenna and, more particularly, to a rod antenna for a vehicle.

### BACKGROUND

Rod antennas for receiving and/or transmitting high-frequency signals are used, for example, in vehicles. The rod antennas have at least one electrical conductor acting as an antenna, the electrical conductor being enclosed by an insulating jacket made of an electrically non-conductive material, for protection against external influences and also for electrical or high-frequency technology reasons.

In the case of such rod-shaped antennas, when they are used on vehicles, there arises the problem that disturbing whistling noises are generated as the speed of the vehicle increases. In order to get rid of such whistling noises, which have an unpleasant high pitch for the listener, consideration has already been given to forming the cross-section of the rod antenna in a polygonal, for example triangular, manner as disclosed in DE 19839046 A1, or additionally to apply a helical conductor onto the rod antenna, which helical conductor extends in the axial direction as disclosed in DE 10260167 A1.

With these two abovementioned measures, the disturbing whistling noises can indeed be reduced, but there is still the disadvantage that they cannot be nearly completely eliminated. Further, the additionally applied helical conductor protrudes beyond the surface of the jacket, creating an aesthetically unappealing rod antenna.

In another rod antenna described in DE 69020282 T2, a helical elevation protrudes beyond the outer surface of the jacket, negatively affecting the appearance. The width of the helical elevation extending in the axial direction of the rod antenna is, in this case, significantly greater, for example greater by at least half, than the width of the helical elevation. As a result, this helical elevation is clearly prominent beyond the surface of the jacket.

### SUMMARY

A rod antenna includes a jacket enclosing an electrical conductor acting as an antenna. The jacket has a groove extending in a spiral manner in an axial direction of the rod antenna.

### BRIEF DESCRIPTION OF THE DRAWINGS

The invention will now be described by way of example with reference to the accompanying FIGURE, of which:

The FIGURE is a front view of a rod antenna according to an embodiment.

### DETAILED DESCRIPTION OF THE EMBODIMENT(S)

Exemplary embodiments of the present invention will be described hereinafter in detail with reference to the attached drawings, wherein like reference numerals refer to like elements. The present invention may, however, be embodied in many different forms and should not be construed as being limited to the embodiments set forth herein. Rather, these embodiments are provided so that the present disclosure will convey the concept of the disclosure to those skilled in the art.

A rod antenna 1 according to an embodiment is shown in the FIGURE. The rod antenna 1 has a jacket 2. At least one electrical conductor (not shown) is disposed within the jacket 2 and, in an embodiment, the at least one electrical conductor has a support (not shown). In an embodiment, the rod antenna 1 is for receiving and/or transmitting high-frequency signals.

As shown in the FIGURE, a groove 3, running in a spiral manner in an axial direction of the rod antenna 1, is introduced into the jacket 2. A width of the groove, defined as a distance between the groove flanks of the groove 3 defining the groove 3, is smaller, and in an embodiment significantly smaller, than the width of the jacket 2 between the groove flanks of the groove 3. In a further embodiment, the width of the jacket 2 between the groove flanks of the groove 3 is at least twice the width of the groove 3 between the groove flanks.

In an embodiment, the groove 3 has an angular cross-section, in particular a square or rectangular cross-section. In the case of such an angular cross-section, where appropriate, the transition regions can be very slightly rounded off, however, the transition regions are not so rounded off that the groove 3 has a U-shaped cross-section.

In the embodiment shown in the FIGURE, a groove base of the groove 3 is formed by the jacket 2. Thus, even with the groove 3, the inner workings of the rod antenna 1, namely the at least one electrical conductor acting as an antenna and, where appropriate, the support, remain protected against external influences.

In the embodiment shown in the FIGURE, the groove 3 extends as an anti-whistle coil over the entire length of the rod antenna 1. In other embodiments, the groove 3 can also be present only over a partial length, that is to say a section, or a plurality of sections of the rod antenna 1. If a vehicle on which the rod antenna 1 is installed is tested in a wind tunnel, for example, it can be that it is already sufficient for the groove 3 as the anti-whistle coil to extend only over a partial length of the rod antenna 1. If it should transpire, however, that this does not yet fully get rid of the disturbing whistling noises, the groove 3 can be introduced over the entire length of the rod antenna 1 in its jacket 2.

In other embodiments, the pitch of the groove 3 and a direction of rotation of the groove 3 can vary. A pitch of the groove 3 is dictated by a length of the rod antenna 1 and of the construction space, for example a surface of the vehicle, in which it is arranged. By way of appropriate tests, for example in a wind tunnel, and a change in the pitch of the groove 3 running in a spiral manner and, where appropriate, also the winding direction, the function of the anti-whistle coil can be optimized.

As shown in the FIGURE, the rod antenna 1 has a screw thread 4 with which the rod antenna 1 can be screwed into a holder which is arranged on a vehicle.

In a method of manufacturing the rod antenna 1, in an embodiment, the at least one electrical conductor is arranged on or in the support and the at least one electrical conductor is enclosed, together with the support, by the jacket 2. In the simplest form, an electrical conductor in the shape of a rod, for example formed from a wire, acting as an antenna is provided, which is enclosed by the jacket 2. Depending on the structural shape and requirements of the rod antenna 1, and also regarding its mechanical properties, such as the load during operation of the vehicle for example, and also regarding the high-frequency properties, the at least one electrical conductor can also be arranged on or at the support. For example, a rod-shaped support can be provided and made from an electrically non-conductive material, around which the electrical conductor has been wound. In another embodiment, a rod-shaped support can also be present, in which a straight or spiral-shaped slot is introduced, into which the at least one electrical conductor is inserted. In another embodiment, a support consisting of an electrically non-conductive material can be coated with an electrical material.

The jacket 2 is thereafter installed, for example, in a casting method or injection-molding method, or as a separate component, which is laid over the electrical conductor or over the support with the electrical conductor.

The groove 3 can be introduced into the jacket 2 according to a number of different embodiments.

In an embodiment, the jacket 2 is first produced, and thereafter the groove 3 is introduced into the jacket 2. The jacket 2 is produced, for example, initially as a separate component independently of the electrical conductor and, where appropriate, the support. Before the jacket 2 is mounted together with the electrical conductor, the groove 3 running in a spiral manner is introduced into the jacket 2. Alternatively, the jacket 2 is initially produced and then mounted together with the at least one electrical conductor, and only when this component is finished, the groove 3 is introduced into the surface of the jacket 2.

In another embodiment, the at least one electrical conductor, with the support in some embodiments, is inserted into a mold and then enclosed with the jacket 2, for example in a casting method, an injection method, an injection-molding method, or the like. Thereafter, the groove 3 can be introduced into the jacket 2.

In another embodiment, the groove 3 is introduced into the jacket 2 simultaneously with the production of the jacket 2. The jacket 2 may be a separate component, and the groove 3 may be introduced into the jacket 2 simultaneously with the production of the jacket 2. If the jacket 2 is produced by a casting, injection, injection-molding method or the like together with the at least one electrical conductor, and the support in some embodiments, it is, however, also conceivable to design the negative mold of the jacket 2 in such a way that the groove 3 can also already be introduced simultaneously with the production of the jacket 2.

Irrespective of the manner in which the jacket 2 is produced and is arranged over the at least one electrical conductor, the jacket 2 has in its entire surface area the groove 3 running in a spiral manner extending in the axial direction, which is introduced into the surface of the jacket 2 as described above.

The groove 3 results in the antenna 1 having a pleasing appearance, because the viewer views the entire surface of the jacket 2 with the exception of the groove 3 running in the spiral manner. The groove 3 is introduced into the smooth surface of the jacket 2 and does not protrude beyond the surface of the jacket 2. Further, with the groove 3 running in the spiral manner in the axial direction of the rod antenna 1, the elimination of the whistling noises is significantly improved.

What is claimed is:

1. A rod antenna, comprising:
a jacket enclosing an electrical conductor acting as an antenna, the jacket has a groove extending in a spiral manner in an axial direction of the rod antenna.

2. The rod antenna of claim 1, wherein the groove has a groove base formed by the jacket.

3. The rod antenna of claim 1, wherein the groove extends over a partial length of the rod antenna.

4. The rod antenna of claim 1, wherein the groove extends over an entire length of the rod antenna.

5. The rod antenna of claim 1, wherein the electrical conductor is arranged on or in a support.

6. The rod antenna of claim 5, wherein the electrical conductor and the support are enclosed by the jacket.

7. The rod antenna of claim 1, wherein the rod antenna is adapted for receiving and/or transmitting high-frequency signals.

8. The rod antenna of claim 1, wherein the rod antenna is installed on a vehicle.

9. A method for producing a rod antenna, comprising:
providing a jacket enclosing an electrical conductor acting as an antenna; and
introducing a groove into the jacket, the groove extending in a spiral manner in an axial direction of the rod antenna.

10. The method of claim 9, wherein the providing step occurs before the introducing step.

11. The method of claim 9, wherein the providing step occurs simultaneously with the introducing step.

12. The method of claim 9, wherein the rod antenna is adapted for receiving and/or transmitting high-frequency signals.

13. The method of claim 9, further comprising installing the rod antenna on a vehicle.
